(19) United States
(12) Patent Application Publication
(10) Pub. No.: US 2024/0007183 A1
(43) Pub. Date: Jan. 4, 2024

(54) MEASURING APPARATUS AND MEASURING METHOD

(71) Applicant: NIPPON TELEGRAPH AND TELEPHONE CORPORATION, Tokyo (JP)

(72) Inventors: Go YAZAWA, Musashino-shi, Tokyo (JP); Shinichi YOSHIHARA, Musashino-shi, Tokyo (JP)

(73) Assignee: NIPPON TELEGRAPH AND TELEPHONE CORPORATION, Tokyo (JP)

(21) Appl. No.: 18/037,281

(22) PCT Filed: Nov. 17, 2020
(86) PCT No.: PCT/JP2020/042705

§ 371 Date: May 16, 2023

(51) Int. Cl. H04B 10/079; H04B 10/70

(52) U.S. Cl. CPC H04B 10/0795; H04B 10/70

(57) ABSTRACT

A measurement device according to an aspect of the present invention includes: a generation unit that generates first and second optical pulse trains in which a time interval between optical pulses is constant; a transmission unit that transmits the first optical pulse train to a device to be measured; a reception unit that receives the first optical pulse train returning from the device to be measured; a measurement unit that measures the number of optical pulses transmitted by the transmission unit from when the transmission unit transmits an optical pulse included in the first optical pulse train to when the reception unit receives the optical pulse; an identification unit that identifies a phase amount corresponding to a phase difference between the received first optical pulse train and the second optical pulse train; and a calculation unit that calculates a propagation delay amount between the measurement device and the device to be measured on the basis of the measured number of optical pulses and the identified phase amount.

### TECHNICAL FIELD

The present invention relates to a quantum key distribution technology.

### BACKGROUND ART

In a quantum key distribution (QKD) system attracting attention in recent years, a transmission device gives quantum information to a weak optical pulse and transmits the optical pulse to a reception device. The reception device generally detects the optical pulse by using an avalanche photodiode (APD). In the detection by the APD, the timing of a gate signal applied to the APD is adjusted in accordance with the arrival of the optical pulse.

An optical fiber is used as an optical transmission line between the transmission device and the reception device. In a general optical fiber, a temperature change occurs in the fiber due to radiation of sunlight or the like, thereby causing a change in transmission time of an optical pulse. Therefore, the time required for an optical pulse to arrive at the reception device after leaving the transmission device is not constant, and it is necessary to adjust the timing of a gate signal for each case.

Non Patent Literature 1 discloses a method for enabling stable signal detection by evaluating signal quality when a reception device receives an optical pulse with an index such as a quantum bit error rate (QBER), and adjusting the timing of a gate signal so as to minimize the index.

### CITATION LIST

### Non Patent Literature

Non Patent Literature 1: A. R. Dixon, “High speed prototype quantum key distribution system and long term field trial”, OPTICS EXPRESS, Vol. 23, No. 6, pp. 7583-7592, 2015.

### SUMMARY OF INVENTION

### Technical Problem

In a case where a code such as quantum information is not assigned to an optical pulse, a timing adjustment method disclosed in Non Patent Literature 1 is not applicable because signal quality cannot be measured. In addition, a measuring instrument for measuring signal quality is required in the reception device, which hinders downsizing of the reception device.

An object of the present invention is to provide a technology that enables simplification of a reception device in a QKD system.

### Solution to Problem

A measurement device according to an aspect of the present invention includes: a generation unit that generates first and second optical pulse trains in which a time interval between optical pulses is constant; a transmission unit that transmits the first optical pulse train to a device to be measured; a reception unit that receives the first optical pulse train returning from the device to be measured; a measurement unit that measures the number of optical pulses transmitted by the transmission unit from when the transmission unit transmits a first optical pulse included in the first optical pulse train to when the reception unit receives the first optical pulse; an identification unit that identifies a phase amount corresponding to a phase difference between the received first optical pulse train and the second optical pulse train; and a calculation unit that calculates a propagation delay amount between the measurement device and the device to be measured on the basis of the measured number of optical pulses and the identified phase amount.

### Advantageous Effects of Invention

According to the present invention, a technology that can simplify a reception device in a QKD system is provided.

### BRIEF DESCRIPTION OF DRAWINGS

FIG. 1 is a block diagram illustrating a quantum key distribution system according to an embodiment.

FIG. 2 is a diagram illustrating a configuration example of a quantum signal transmitter and a quantum signal receiver illustrated in FIG. 1.

FIG. 3 is a diagram illustrating a configuration example of a measurement device illustrated in FIG. 1.

FIG. 4 is a diagram for describing an evaluation unit illustrated in FIG. 3.

FIG. 5 is a flowchart illustrating an operation example of the measurement device of FIG. 3.

FIG. 6 is a block diagram illustrating a hardware configuration example of the measurement device illustrated in FIG. 1.

### DESCRIPTION OF EMBODIMENTS

Hereinafter, an embodiment of the present invention will be described with reference to the drawings.

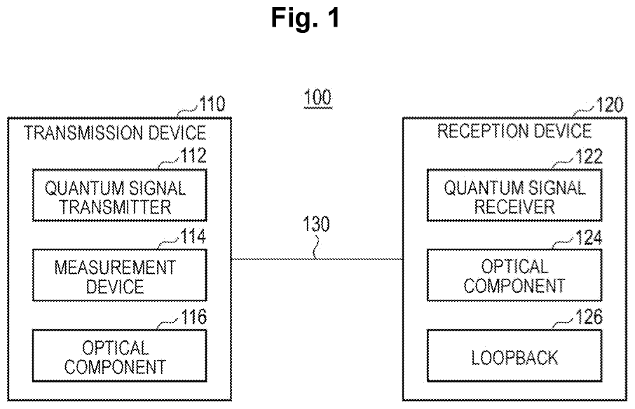

FIG. 1 schematically illustrates a configuration example of a quantum key distribution (QKD) system 100 according to an embodiment of the present invention. As illustrated in FIG. 1, the QKD system 100 includes a transmission device 110 and a reception device 120. The transmission device 110 is connected to the reception device 120 via an optical transmission line 130. The optical transmission line 130 may be an optical fiber such as a single mode fiber. The optical transmission line 130 may pass through an optical fiber network (not illustrated). The transmission device 110 may be connected to a plurality of reception devices including the reception device 120.

The transmission device 110 includes a quantum signal transmitter 112, a measurement device 114, and an optical component 116.

The quantum signal transmitter 112 transmits an optical signal as a quantum signal to the reception device 120 in order to generate an encryption key shared between the transmission device 110 and the reception device 120.

The measurement device 114 measures a propagation delay amount between the transmission device 110 (measurement device 114) and the reception device 120. The propagation delay amount between the transmission device 110 and the reception device 120 indicates the time until an optical signal exits from the transmission device 110 and arrives at the reception device 120. The reception device 120 is also referred to as a device to be measured.

The optical component 116 multiplexes an optical signal from the quantum signal transmitter 112 and an optical signal from the measurement device 114 into the optical transmission line 130. Furthermore, the optical component 116 guides the optical signal emitted from the measurement device 114 and returning from the reception device 120 to the measurement device 114. Examples of the optical component 116 include an optical switch, a polarizing beam splitter, a wavelength division multiplexing (WDM) coupler, and the like.

The reception device 120 includes a quantum signal receiver 122, an optical component 124, and a loopback 126.

The quantum signal receiver 122 receives an optical signal as a quantum signal from the transmission device 110 in order to generate an encryption key shared between the transmission device 110 and the reception device 120.

The optical component 124 guides an optical signal from the quantum signal transmitter 112 to the quantum signal receiver 122 and directs an optical signal from the measurement device 114 to the loopback 126. Examples of the optical component 124 include an optical switch, a polarizing beam splitter, a WDM coupler, and the like.

The loopback 126 loops back an optical signal. An optical signal emitted from the measurement device 114 propagates through the optical transmission line 130 to the reception device 120, turns back at the loopback 126 of the reception device 120, and propagates through the optical transmission line 130 to the measurement device 114.

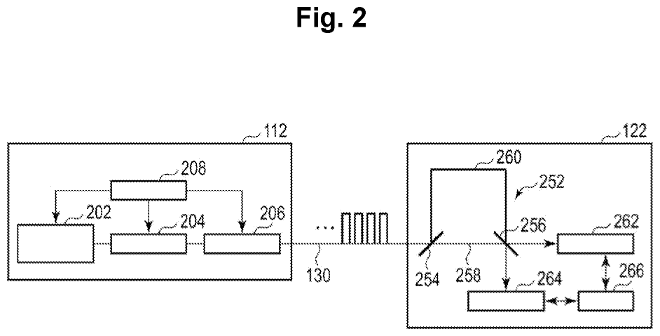

FIG. 2 schematically illustrates a configuration example of the quantum signal transmitter 112 and the quantum signal receiver 122 in a case where a differential phase shift (DPS) QKD protocol is adopted as the QKD protocol. In FIG. 2, illustration of the measurement device 114, the optical components 116 and 124, and the loopback 126 is omitted.

As illustrated in FIG. 2, the quantum signal transmitter 112 includes a light source 202, a modulator 204, an attenuator 206, and a control circuit 208. The control circuit 208 controls the light source 202, the modulator 204, and the attenuator 206.

The light source 202 generates optical pulses at regular intervals. In one example, the light source 202 may generate linearly polarized optical pulses. The light source 202 can be, but is not limited to, a laser diode. The light source 202 is driven by a control signal applied by the control circuit 208. The control signal is, for example, a voltage signal having a predetermined frequency (e.g., 1 GHz), whereby the light source 202 generates optical pulses at time intervals (e.g., 1 nanosecond intervals) corresponding to the above frequency. The light source 202 outputs an optical pulse train in which the time interval between pulses is constant.

The modulator 204 modulates the phase of each optical pulse included in the optical pulse train output from the light source 202. Specifically, the control circuit 208 randomly selects the phase shift of either 0 or n for each optical pulse, and the modulator 204 applies the phase shift selected by the control circuit 208 to the optical pulse. The control circuit 208 records phase modulation data indicating the phase shift applied to each optical pulse.

The attenuator 206 attenuates the optical pulses such that the average number of photons per pulse is less than 1. The attenuator 206 transmits the attenuated optical pulse to the optical transmission line 130.

The quantum signal receiver 122 includes an interferometer 252, detectors 262 and 264, and a control circuit 266. The interferometer 252 is an asymmetric Mach-Zehnder interferometer including a beam splitter 254 and a coupler 256. The optical transmission line 130 is connected to an input port of the beam splitter 254. A first output port of the beam splitter 254 is connected to a first input port of the coupler 256 by a waveguide 258, and a second output port of the beam splitter 254 is connected to a second input port of the coupler 256 by a waveguide 260. The optical path length of the waveguide 260 is longer than the optical path length of the waveguide 258. A first output port of the coupler 256 is connected to the detector 262, and a second output port of the coupler 256 is connected to the detector 264.

The beam splitter 254 splits each optical pulse of the optical pulse train incident on the quantum signal receiver 122, and guides a part of the optical pulse to the waveguide 258 and the remaining part of the optical pulse to the waveguide 260. Typically, the splitting ratio of the beam splitter 254 is 1:1. The waveguide 260 delays an optical pulse by a predetermined delay time with respect to an optical pulse moving through the waveguide 258. The predetermined delay time is equal to the time interval between the pulses. The coupler 256 multiplexes an optical pulse train moving through the waveguide 258 and an optical pulse train moving through the waveguide 260. Adjacent optical pulses interfere at the coupler 256, and as a result of the interference, a photon is detected at either of the detectors 262 and 264. For example, if the phase difference between adjacent pulses is 0, the detector 262 detects a photon, and if the phase difference between adjacent pulses is n, the detector 264 detects a photon.

The detectors 262 and 264 may be single photon detectors, such as avalanche photodiodes (APD). When APD is used, gate operation may be applied to reduce after-pulse noise. The gate operation causes the APD to go into Geiger mode for a short time in accordance with the time at which detection of a photon is predicted. The control circuit 266 applies a gate signal for operating in Geiger mode to the APD. In a case where an optical fiber is used as the optical transmission line 130, a propagation delay amount changes due to a factor such as a temperature change occurring in the fiber. Therefore, it is necessary to adjust the timing of the gate signal according to the propagation delay amount.

The transmission device 110 and the reception device 120 generate an encryption key by the following procedure.

First, after receiving an optical pulse train, the quantum signal receiver 122 notifies the quantum signal transmitter 112 of the photon detection time. Subsequently, the quantum signal transmitter 112 finds out which one of the detectors 262 and 264 has detected a photon from the notified photon detection time and phase modulation data. In the quantum signal transmitter 112 and the quantum signal receiver 122, an event in which a photon is detected by the detector 262 is set to a bit “1”, and an event in which a photon is detected by the detector 264 is set to a bit “0”.

Through the above operation, the quantum signal transmitter 112 and the quantum signal receiver 122 obtain the same bit string. Information disclosed to the outside is only the photon detection time, and bit information is not disclosed. Therefore, the transmission device 110 and the reception device 120 use the bit string as an encryption key.

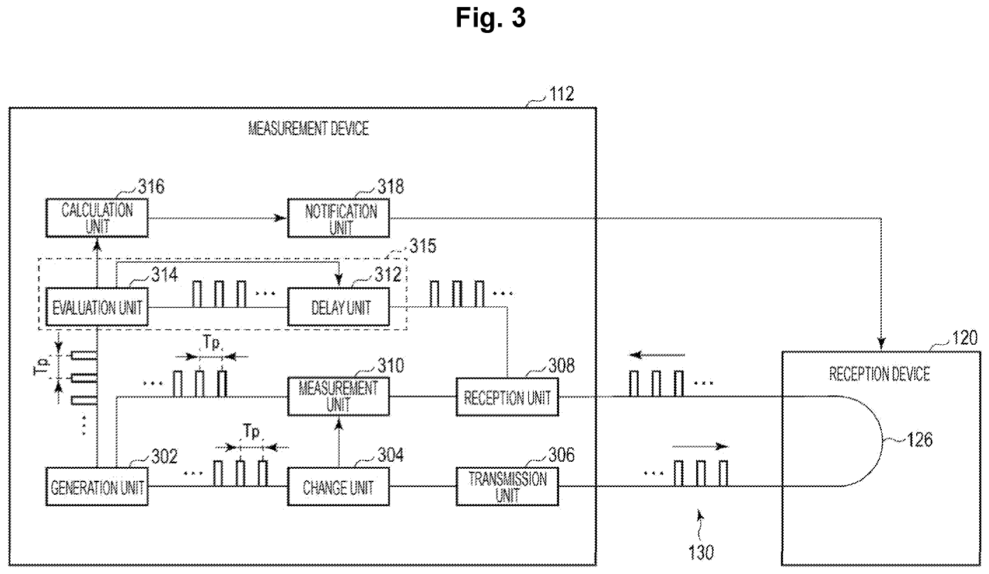

FIG. 3 schematically illustrates a configuration example of the measurement device 114. In FIG. 3, illustration of the quantum signal transmitter 112, the optical component 116, the quantum signal receiver 122, and the optical component 124 is omitted.

As illustrated in FIG. 3, the measurement device 114 includes a generation unit 302, a change unit 304, a transmission unit 306, a reception unit 308, a measurement unit 310, an adjustment unit 312, an evaluation unit 314, a calculation unit 316, and a notification unit 318. The generation unit 302 is connected to the change unit 304, the measurement unit 310, and the evaluation unit 314 by an optical fiber. The change unit 304 is connected to the transmission unit 306 by an optical fiber. The transmission unit 306 and the reception unit 308 correspond to ports of the measurement device 114 connected to the optical component 116 illustrated in FIG. 1. The reception unit 308 is connected to the measurement unit 310 and the adjustment unit 312 by an optical fiber. For example, a beam splitter is provided at a subsequent stage of the reception unit 308, and a first output port of the beam splitter is connected to the measurement unit 310 while a second output port of the beam splitter is connected to the adjustment unit 312. The adjustment unit 312 is connected to the evaluation unit 314 by an optical fiber.

The generation unit 302 generates three optical pulse trains having a constant time interval between optical pulses. For example, the generation unit 302 includes a light source and two beam splitters. The light source generates optical pulses at regular intervals. A time interval at which the light source generates optical pulses is denoted as T_{P}. The time interval T_{P} may be, for example, 1 nanosecond. As the light source, for example, an active mode locking laser can be used. An active mode locking laser is a laser that repeatedly generates and outputs a pulse by synchronizing an optical transmission distance between mirrors and a modulation frequency of an optical pulse and forcibly modulating light. The optical pulse train generated by the light source is divided into three by two beam splitters, thereby generating three optical pulse trains with a constant time interval between the optical pulses. The optical pulse trains are synchronously emitted from the generation unit 302. Each of the optical pulse trains is supplied to the change unit 304, the measurement unit 310, and the evaluation unit 314. The generation unit 302 may use the light source 202 illustrated in FIG. 2.

Hereinafter, an optical pulse train headed toward the change unit 304 is also referred to as a target optical pulse train, and an optical pulse included in a target optical pulse train is also referred to as a target optical pulse. An optical pulse train headed toward the evaluation unit 314 is also referred to as a reference optical pulse train, and an optical pulse included in a reference optical pulse train is also referred to as a reference optical pulse.

The change unit 304 changes at least one of the target optical pulses included in the target optical pulse train so that the target optical pulse is identifiable. For example, the change unit 304 changes a feature of at least one target optical pulse. Examples of the feature include polarization, amplitude, intensity, and pulse width. In the present embodiment, the change unit 304 changes one target optical pulse so that the target optical pulse is identifiable, and sends a notification signal indicating execution of the change processing to the measurement unit 310.

In one example, the change unit 304 may be an encoder that encodes information (“0” or “1”) into optical pulses. In a scheme of encoding information into a polarization state of an optical pulse, the change unit 304 modulates polarization of the target optical pulse. For example, in a case where the generation unit 302 generates an S-polarized optical pulse, the change unit 304 modulates polarization of the target optical pulse to P-polarization.

In another example, the change unit 304 adjusts the amplitude of the target optical pulse. For example, when the generation unit 302 generates an optical pulse having a first amplitude, the change unit 304 adjusts the amplitude of the target optical pulse to a second amplitude. The second amplitude may be larger or smaller than the first amplitude as long as the second amplitude is different from the first amplitude.

The transmission unit 306 transmits the target optical pulse train that has passed through the change unit 304 to the reception device 120. The target optical pulse train emitted from the measurement device 114 propagates through the optical transmission line 130 to the reception device 120, turns back at the loopback 126 of the reception device 120, and propagates through the optical transmission line 130 to the measurement device 114. The reception unit 308 receives the target optical pulse train returning from the reception device 120, and guides the received target optical pulse train to the measurement unit 310 and the adjustment unit 312.

The measurement unit 310 measures the number of optical pulses transmitted by the transmission unit 306 from when the transmission unit 306 transmits a certain target optical pulse to when the reception unit 308 receives the target optical pulse. For example, the measurement unit 310 includes a photodetector, and uses the photodetector to count the optical pulses incident from the generation unit 302 from the time when the transmission unit 306 transmits the identifiable target optical pulse (target optical pulse whose feature has been changed) to the time when the reception unit 308 receives the identifiable target optical pulse. The measurement unit 310 may recognize the time when a notification signal is received from the change unit 304 as the time when the transmission unit 306 transmits the identifiable target optical pulse. The measurement unit 310 may identify the identifiable target optical pulse, and recognize the time when the identifiable target optical pulse is received as the time when the reception unit 308 receives the identifiable target optical pulse. In an example in which the change unit 304 modulates polarization of the target optical pulse to P-polarization, the measurement unit 310 may further include a polarizing beam splitter and another photodetector. The polarizing beam splitter is provided to selectively guide optical pulses of P-polarization to the other photodetector. The measurement unit 310 may recognize the time when the other photodetector detects the optical pulse as the time when the reception unit 308 receives the identifiable target optical pulse.

The adjustment unit 312 and the evaluation unit 314 correspond to an identification unit 315 that identifies a phase amount corresponding to the phase difference between a target optical pulse train received by the reception unit 308 and a reference optical pulse train. The phase amount is a time within a range from 0 seconds to the time T_{P}. When the phase difference is represented as θ and the phase amount is represented as T_{D}, T_{D}=(θ/2n) T_{P}.

The adjustment unit 312 adjusts the phase of a target optical pulse train received by the reception unit 308. The evaluation unit 314 evaluates the correlation between the reference optical pulse train and the target optical pulse train whose phase has been adjusted. The evaluation unit 314 sends a control signal for controlling the phase shift amount to the adjustment unit 312, and the adjustment unit 312 adjusts the phase of the target optical pulse train according to the phase shift amount indicated by the control signal. The evaluation unit 314 evaluates the correlation while sequentially changing the phase shift amount. The evaluation unit 314 identifies the phase shift amount with the highest correlation as the phase amount. In other words, the evaluation unit 314 identifies, as the phase amount, the phase shift amount when the reference optical pulse train is synchronized with the target optical pulse train whose phase has been adjusted.

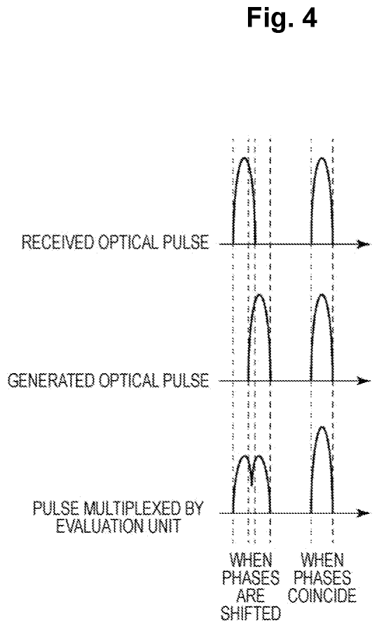

In one example, the evaluation unit 314 may include a coupler that multiplexes the reference optical pulse train and the target optical pulse train whose phase has been adjusted, and a measuring instrument that measures the amplitude of the optical pulse train obtained by the coupler. The highest correlation occurs when the phase of the target optical pulse train whose phase has been adjusted coincides with the phase of the reference optical pulse train. In this case, as illustrated in FIG. 4, since the optical pulses completely overlap, the amplitude is maximized.

In one example, the adjustment unit 312 includes a variable delay line and delays the target optical pulse train received by the reception unit 308 using the variable delay line. The evaluation unit 314 sends a control signal for controlling the delay time to the adjustment unit 312, and the adjustment unit 312 delays the target optical pulse train by the delay time indicated by the control signal. The evaluation unit 314 evaluates the correlation while sequentially changing the delay time. The evaluation unit 314 identifies the delay time with the highest correlation. The evaluation unit 314 calculates the phase amount from the identified delay time. Specifically, the evaluation unit 314 obtains the phase amount by subtracting the identified delay time from the time T_{P}.

The calculation unit 316 calculates a propagation delay amount between the measurement device 114 and the reception device 120 on the basis of the number of optical pulses measured by the measurement unit 310 and the phase amount identified by the evaluation unit 314. For example, a propagation delay amount T between the measurement device 114 and the reception device 120 is calculated by the following Formula (1).

T=(N_{P}·T_{P}+T_{D})/2 (1)

Here, N_{P} represents the number of optical pulses measured by the measurement unit 310, T_{P} represents the interval between optical pulses, and T_{D} represents the phase amount identified by the evaluation unit 314. 2T represents the time required for the optical pulse to travel back and forth between the measurement device 114 and the reception device 120.

The notification unit 318 notifies the reception device 120 of the propagation delay amount calculated by the calculation unit 316. The notification is sent on a classical channel. The control circuit 266 (FIG. 2) of the quantum signal receiver 122 receives the notification from the measurement device 114, and controls the gate signal applied to the detectors 262 and 264 on the basis of the propagation delay amount indicated by the received notification.

In one example, the quantum signal transmitter 112 and the measurement device 114 may emit optical pulse trains of different polarizations. For example, the quantum signal transmitter 112 emits an S-polarized optical pulse train, and the measurement device 114 emits a P-polarized optical pulse train. In this case, a polarizing beam splitter can be used as the optical components 116 and 124.

In one example, the quantum signal transmitter 112 and the measurement device 114 may emit optical pulse trains at different wavelengths. In other words, a first wavelength used when the target optical pulse train is transmitted to the reception device 120 may be different from a second wavelength used when the quantum signal is transmitted to the reception device 120. In this case, a WDM coupler can be used as the optical components 116 and 124. The calculation unit 316 corrects the propagation delay amount on the basis of the difference between the first wavelength and the second wavelength. For example, the calculation unit 316 calculates a propagation delay amount T′ related to the second wavelength by the following Formula (2).

$${T}^{′} = T + Δ T = T + ( D \times Δλ \times L ) \qquad ( 2 )$$

Here, ΔT represents a propagation delay difference, D represents wavelength dispersion of an optical fiber used as the optical transmission line 130, Δλ represents a wavelength difference, and L represents a distance of the optical transmission line 130. The wavelength difference Δλ is a value obtained by subtracting the second wavelength from the first wavelength. The wavelength dispersion D of the optical fiber is a value determined by a total value of dispersion amounts caused by the structure and material of the optical fiber. As a unit of the wavelength dispersion D, “ps/nm/km” is usually used. This refers to a group delay time difference (ps) generated between components having wavelengths different by 1 nm when an optical wave propagates by 1 km. For example, in a single mode fiber which is one type of generally used optical fibers, it is known that the wavelength dispersion D at a wavelength around 1.55 μm having the smallest propagation loss is about 17 ps/nm/km. The notification unit 318 notifies the reception device 120 of the propagation delay amount T′ obtained by the correction.

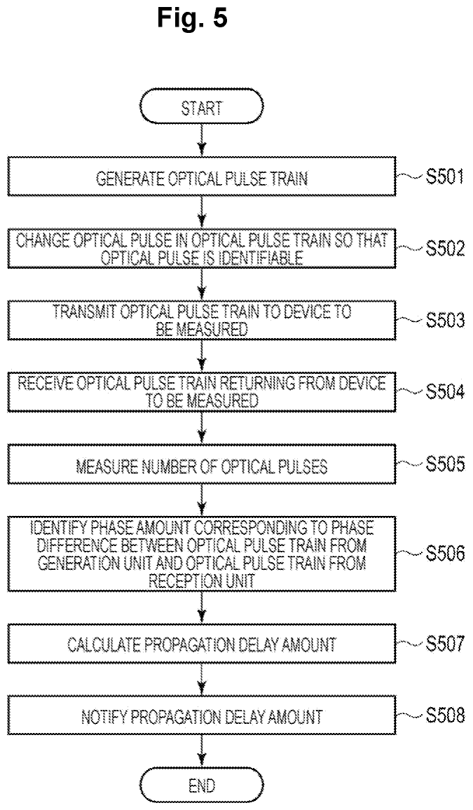

FIG. 5 schematically illustrates a procedure example in which the measurement device 114 measures the propagation delay amount between the measurement device 114 and the reception device 120 as the device to be measured.

In step S501 of FIG. 5, the generation unit 302 generates three optical pulse trains, and outputs these optical pulse trains to the change unit 304, the measurement unit 310, and the evaluation unit 314. In each optical pulse train, the time interval between the optical pulses is constant.

In step S502, the change unit 304 changes a target optical pulse included in a target optical pulse train that is an optical pulse train output from the generation unit 302, so that the target optical pulse is identifiable. For example, the change unit 304 adjusts the amplitude of the target optical pulse. For example, the generation unit 302 generates optical pulses having a first amplitude, and the change unit 304 adjusts one of the optical pulses to a second amplitude. The change unit 304 notifies the measurement unit 310 that the amplitude has been adjusted.

In step S503, the transmission unit 306 transmits the target optical pulse train that has passed through the change unit 304 to the reception device 120. In step S504, the reception unit 308 receives the target optical pulse train returning from the reception device 120.

In step S505, the measurement unit 310 measures the number of optical pulses transmitted by the transmission unit 306 from when the transmission unit 306 transmits the target optical pulse to when the reception unit 308 receives the target optical pulse. For example, the measurement unit 310 starts counting the optical pulses incident from the generation unit 302 when receiving the notification from the change unit 304, and ends the counting when detecting the target optical pulse having the second amplitude.

In step S506, the identification unit 315 identifies the phase amount corresponding to the phase difference between the target optical pulse train received by the reception unit 308 and the reference optical pulse train. For example, the adjustment unit 312 adjusts the phase of the target optical pulse train received by the reception unit 308 according to the phase shift amount indicated by a control signal received from the evaluation unit 314. The evaluation unit 314 evaluates the correlation between the reference optical pulse train and the target optical pulse train whose phase has been adjusted. The evaluation unit 314 identifies the phase shift amount with the highest correlation as the phase amount.

In step S507, the calculation unit 316 calculates the propagation delay amount between the measurement device 114 and the reception device 120 on the basis of the number of optical pulses obtained by the measurement unit 310 and the phase amount identified by the identification unit 315. For example, the calculation unit 316 calculates the propagation delay amount according to the above-described Formula (1).

In step S508, the notification unit 318 notifies the reception device 120 of the propagation delay amount calculated by the calculation unit 316.

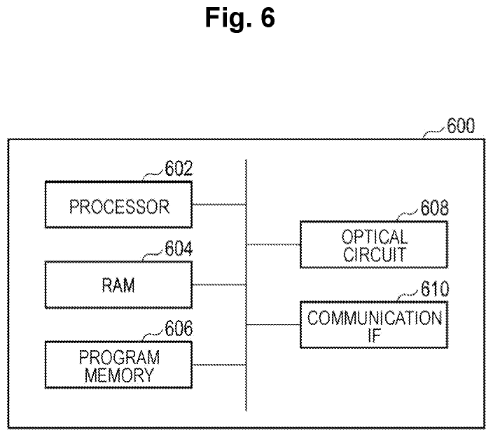

FIG. 6 schematically illustrates a hardware configuration example of the measurement device 114. As illustrated in FIG. 6, the measurement device 114 includes a processor 602, a random access memory (RAM) 604, a program memory 606, an optical circuit 608, and a communication interface 610.

The optical circuit 608 includes the generation unit 302, the change unit 304, the transmission unit 306, the reception unit 308, the measurement unit 310, the adjustment unit 312, and the evaluation unit 314 illustrated in FIG. 3. For example, the optical circuit 608 includes a plurality of optical components such as a light source and a beam splitter included in the generation unit 302 and a photodetector included in the measurement unit 310.

The processor 602 includes a general-purpose circuit such as a central processing unit (CPU). The RAM 604 is used as a working memory by the processor 602. The RAM 604 includes a volatile memory such as a synchronous dynamic random access memory (SDRAM). The program memory 606 stores programs executed by the processor 602, such as a propagation delay amount measurement program. The programs include computer-executable instructions. For example, a read-only memory (ROM) is used as the program memory 606.

The processor 602 develops the programs stored in the program memory 606 in the RAM 604, and interprets and executes the programs. When executed by the processor 602, the propagation delay amount measurement program causes the processor 602 to perform control of the optical circuit 608 and the communication interface 610, the processing described in regard to the calculation unit 316, and the like. The control of the optical circuit 608 includes generation of a control signal for controlling the phase shift amount.

The communication interface 610 is an interface for communicating with an external device on a classical channel. The communication interface 610 is used to transmit a signal indicating a propagation delay amount to the reception device 120.

At least a part of the processing including the control of the optical circuit 608 and the communication interface 610 and the processing described in regard to the calculation unit 316 may be implemented by a dedicated circuit such as a field programmable gate array (FPGA) or an application specific integrated circuit (ASIC).

As described above, in the measurement device 114, the generation unit 302 generates the target optical pulse train and the reference optical pulse train, the transmission unit 306 transmits the target optical pulse train to the reception device 120, the reception unit 308 receives the target optical pulse train returning from the reception device 120, the measurement unit 310 measures the number of optical pulses transmitted by the transmission unit 306 from when the transmission unit 306 transmits a certain optical pulse to when the reception unit 308 receives the optical pulse, the identification unit identifies the phase amount corresponding to the phase difference between the target optical pulse train received by the reception unit 308 and the reference optical pulse train, and the calculation unit 316 calculates the propagation delay amount between the measurement device 114 and the reception device 120 on the basis of the measured number of optical pulses and the identified phase amount. According to this configuration, the transmission device 110 can measure the propagation delay amount. Therefore, it is not necessary to provide a device such as a measuring instrument in the reception device 120. As a result, the reception device 120 can be simplified. This enables downsizing of the reception device 120. In a P-to-MP configuration in which the transmission device 110 is connected to a plurality of reception devices, simplification of the reception device is effective in reducing the cost of the entire system.

The measurement device 114 may change at least one target optical pulse so that the target optical pulse is identifiable, and transmit a target optical pulse train including the identifiably changed target optical pulse to the reception device 120. For example, the measurement device 114 may encode information into at least one target optical pulse. The measurement device 114 may adjust the amplitude of at least one target optical pulse. By identifiably changing at least one target optical pulse, it becomes easy to determine a period for measuring the number of optical pulses.

The measurement device 114 adjusts the phase of the received target optical pulse train and evaluates the correlation between the target optical pulse train whose phase has been adjusted and the reference optical pulse train. The measurement device 114 identifies the phase shift amount with the highest correlation as the phase amount. As a result, the propagation delay amount can be measured accurately.

The measurement device 114 notifies the reception device 120 of the calculated propagation delay amount. As a result, the timing of the gate signal applied to the APD can be adjusted appropriately in the reception device 120.

In a case where a first wavelength used when the target optical pulse train is transmitted to the reception device 120 is different from a second wavelength used when a quantum signal is transmitted to the reception device 120, the measurement device 114 corrects the propagation delay amount on the basis of the difference between the first wavelength and the second wavelength. As a result, it is possible to measure the time required for the quantum signal to leave the transmission device 110 and arrive at the reception device 120 accurately.

The present invention is not limited to the example described above.

In the example illustrated in FIG. 3, the adjustment unit 312 is provided between the reception unit 308 and the evaluation unit 314. Alternatively, the adjustment unit 312 may be provided between the generation unit 302 and the evaluation unit 314. In this case, the adjustment unit 312 adjusts the phase of the reference optical pulse train from the generation unit 302 headed toward the evaluation unit 314.

In the example illustrated in FIG. 3, the generation unit 302 generates three optical pulse trains. Alternatively, the generation unit 302 may generate two optical pulse trains, namely a reference optical pulse train and a target optical pulse train. In this case, a beam splitter may be provided between the change unit 304 and the transmission unit 306, and this beam splitter may generate an optical pulse train to be supplied to the measurement unit 310.

The change unit 304 may be eliminated. In this case, for example, the measurement unit 310 may count the optical pulses incident from the generation unit 302 from the timing when the generation unit 302 starts outputting the optical pulse train to the timing when the measurement unit 310 receives the first optical pulse via the reception unit 308.

Note that the present invention is not limited to the foregoing embodiments and various modifications can be made in the implementation stage without departing from the gist of the invention. In addition, the embodiments may be implemented in appropriate combination, and in this case, combined effects can be obtained. Furthermore, the above embodiments include various inventions, and various inventions can be extracted by combinations selected from the plurality of disclosed components. For example, in a case where the problem can be solved and the effects can be obtained even if some components are deleted from all the components described in the embodiments, a configuration from which the components are eliminated can be extracted as an invention.

### REFERENCE SIGNS LIST

100 Quantum key distribution (QKD) system
110 Transmission device
112 Quantum signal transmitter
114 Measurement device
116 Optical component
120 Reception device
122 Quantum signal receiver
124 Optical component
126 Loopback
130 Optical transmission line
202 Light source
204 Modulator
206 Attenuator
208 Control circuit
252 interferometer
254 Beam splitter
256 Coupler
258 Waveguide
260 Waveguide
262 Detector
264 Detector
266 Control circuit
302 Generation unit
304 Change unit
306 Transmission unit
308 Reception unit
310 Measurement unit
312 Adjustment unit
314 Evaluation unit
315 Identification unit
316 Calculation unit
318 Notification unit
602 Processor
604 RAM
606 Program memory
608 Optical circuit
610 Communication interface

1. A measurement device comprising:
a generation unit that generates first and second optical pulse trains in which a time interval between optical pulses is constant;
a transmission unit that transmits the first optical pulse train to a device to be measured;
a reception unit that receives the first optical pulse train returning from the device to be measured;
a measurement unit that measures the number of optical pulses transmitted by the transmission unit from when the transmission unit transmits an optical pulse included in the first optical pulse train to when the reception unit receives the optical pulse;
an identification unit that identifies a phase amount corresponding to a phase difference between the received first optical pulse train and the second optical pulse train; and
a calculation unit that calculates a propagation delay amount between the measurement device and the device to be measured on the basis of the measured number of optical pulses and the identified phase amount.

2. The measurement device according to claim 1 further comprising a change unit that changes the optical pulse so that the optical pulse is identifiable, wherein
the transmission unit transmits the first optical pulse train including the identifiably changed optical pulse to the device to be measured.

3. The measurement device according to claim 2, wherein
the change unit encodes information into the optical pulse.

4. The measurement device according to claim 2, wherein
the change unit adjusts an amplitude of the optical pulse.

5. The measurement device according to claim 1, wherein:
the identification unit includes
an adjustment unit that adjusts a phase of a third optical pulse train that is one of the received first optical pulse train and the second optical pulse train, and
an evaluation unit that evaluates a correlation between the third optical pulse train whose phase has been adjusted and a fourth optical pulse train that is the other of the received first optical pulse train and the second optical pulse train; and
the identification unit identifies, as the phase amount, a phase shift amount applied to the third optical pulse train by the adjustment unit when the correlation is the highest.

6. The measurement device according to claim 1 further comprising a notification unit that notifies the device to be measured of the calculated propagation delay amount.

7. The measurement device according to claim 1, wherein
the calculation unit corrects the propagation delay amount on the basis of a difference between a first wavelength and a second wavelength when the first wavelength used for transmitting the first optical pulse train to the device to be measured is different from the second wavelength used for transmitting a quantum signal to the device to be measured.

8. A measurement method executed by a measurement device, the measurement method comprising:
generating first and second optical pulse trains in which a time interval between optical pulses is constant;
transmitting the first optical pulse train to a device to be measured;
receiving the first optical pulse train returning from the device to be measured;
measuring the number of optical pulses transmitted by the measurement device from when the measurement device transmits an optical pulse included in the first optical pulse train to when the measurement device receives the optical pulse;
identifying a phase amount corresponding to a phase difference between the received first optical pulse train and the second optical pulse train; and
calculating a propagation delay amount between the measurement device and the device to be measured on the basis of the measured number of optical pulses and the identified phase amount.
